(19) United States
(12) Patent Application Publication
(10) Pub. No.: US 2026/0138418 A1
(43) Pub. Date: May 21, 2026

(54) VEHICLE AIR CONDITIONING DEVICE

(71) Applicant: Sanden Corporation, Isesaki-shi, Gunma (JP)

(72) Inventors: Mizuki OKADA, Isesaki-shi, Gunma (JP); Yunsheng HUANG, Isesaki-shi, Gunma (JP); Hiroto MAJIMA, Isesaki-shi, Gunma (JP); Hongming ZHANG, Isesaki-shi, Gunma (JP)

(73) Assignee: Sanden Corporation, Isesaki-shi, Gunma (JP)

(21) Appl. No.: 19/120,171

(22) PCT Filed: Sep. 28, 2023
(86) PCT No.: PCT/JP2023/035331

§ 371 Date: Apr. 10, 2025

(30) Foreign Application Priority Data
Oct. 25, 2022 (JP) 2022-170298

(51) Int. Cl. B60H 1/00

(52) U.S. Cl. CPC B60H 1/00899

(57) ABSTRACT

A vehicle air-conditioning device includes a control device that controls a refrigerant circuit and an air-conditioning unit. The refrigerant circuit has a hot gas bypass that decompresses at least part of refrigerant compressed by a compressor without the refrigerant passing through an indoor heat exchange unit and an external heat exchange unit, and returns the decompressed refrigerant to the compressor. The control device is capable of executing a hot gas heating operation of heating the inside of a cabin by causing part of the refrigerant compressed by the compressor to dissipate heat in the indoor heat exchange unit without causing the refrigerant to absorb heat in the external heat exchange unit, and opens and closes at least one of a decompression unit provided between the indoor heat exchange unit and the compressor or a hot gas decompression unit provided in the hot gas bypass during the hot gas heating operation.

### TECHNICAL FIELD

The present invention relates to a vehicle air-conditioning device.

### BACKGROUND ART

An air-conditioning device using a heat pump (refrigerant circuit) as a heat source has been known as an air-conditioning device for an electric vehicle (EV) having no heat source of a combustion system such as an engine or a vehicle having a small amount of heat of a heat source of a combustion system.

The air-conditioning device using the heat pump causes an external heat exchanger to function as a heat absorber during a heating operation to obtain a heating heat source from outside air. For this reason, when an outside air temperature becomes extremely low, it becomes difficult to absorb heat from the outside air, and a heating capacity is significantly reduced. On the other hand, for example, when the heat source is secured using an electric heater such as a PTC heater, the consumption of a battery increases, and in the case of the electric vehicle or the like, there is a concern about an adverse effect on a driving distance, and the manufacturing cost of the air-conditioning device increases due to installation of the PTC heater.

Hot gas heating using high-temperature high-pressure refrigerant discharged from a compressor of a refrigerant circuit is a heating method not involving heat absorption, and is expected as effective heating under extremely-low temperature environment. In this hot gas heating, an indoor heat exchanger of a vehicle air-conditioning device functions as a radiator (indoor condenser), the high-temperature high-pressure refrigerant discharged from the compressor directly flows into the indoor heat exchanger, and the refrigerant discharged from the radiator is decompressed and then returned to the compressor through an accumulator without the refrigerant passing through an external heat exchanger (see Patent Literature 1 below).

### CITATION LIST

### Patent Literature

Patent Literature 1: JP-A-2014-196017

### SUMMARY OF INVENTION

### Problems to be Solved by the Invention

In order to effectively continue the hot gas heating operation, it is necessary to achieve a balance between the amount of heat dissipated in the refrigerant circuit and the energy consumption (heat input amount) of the compressor by limiting the heat dissipation in the refrigerant circuit to the indoor condenser as much as possible. In addition, it is necessary to gasify the liquid refrigerant condensed by the heat dissipation in the indoor condenser without evaporating the liquid refrigerant and to return such refrigerant to the compressor.

In order to achieve this object, a bypass refrigerant channel (hot gas bypass) for hot gas heating, in which the high-temperature high-pressure refrigerant discharged from the compressor is partially branched and decompressed without passing through the heat exchanger and is returned to the compressor, is provided in addition to a refrigerant channel through which the high-temperature high-pressure refrigerant discharged from the compressor dissipates heat in the indoor condenser and then decompressed and returned to the compressor.

With such a hot gas bypass, it is possible to mix the gas refrigerant having passed through the hot gas bypass with the liquid refrigerant condensed by heat dissipation in the indoor condenser to obtain the gas-rich refrigerant and then return such refrigerant to the compressor. In addition, by increasing the flow rate of refrigerant flowing through the hot gas bypass, the amount of heat dissipated in the indoor condenser can be reduced, and by adjusting the flow rate of refrigerant flowing through the hot gas bypass, a balance between the amount of heat dissipated in the refrigerant circuit and the amount of heat input to the compressor can be maintained.

In such a hot gas heating operation, the heating capacity can be adjusted by controlling the rotation speed of the compressor as in normal heat absorption heating.

However, in order to increase the heating capacity in hot gas heating, there is a case where the compressor is operated at the rotation speed in the vicinity of the upper limit, and in such a case where it is necessary to further improve the heating capacity, there is a problem that only the control of the rotation speed of the compressor is not enough.

Further, in consideration of the durability of the compressor, it is necessary to decrease the suction pressure of the compressor. However, in a case where hot gas heating is continued, the operation is continued in a state in which the suction pressure of the compressor is high, and there is a problem that it is difficult to efficiently continue hot gas heating in consideration of the durability of the compressor.

An object of the present invention is to cope with such a problem. That is, an object of the present invention is, for example, to make it possible to adjust the heating capacity in hot gas heating when only the control of the rotation speed of the compressor is not enough and to efficiently continue hot gas heating in consideration of the durability of the compressor.

### Solution to Problems

In order to solve such a problem, the present invention has the following configuration.

A vehicle air-conditioning device includes a refrigerant circuit including a compressor, an indoor heat exchange unit, and an external heat exchange unit, an air-conditioning unit in which the indoor heat exchange unit is disposed, and a control device that controls the refrigerant circuit and the air-conditioning unit, the refrigerant circuit has a hot gas bypass that decompresses at least part of refrigerant compressed by the compressor without the refrigerant passing through the indoor heat exchange unit and the external heat exchange unit, and returns the decompressed refrigerant to the compressor, and the control device is capable of executing a hot gas heating operation of heating the inside of a cabin by causing part of the refrigerant compressed by the compressor to dissipate heat in the indoor heat exchange unit without causing the refrigerant to absorb heat in the external heat exchange unit, and opens and closes at least one of a decompression unit provided between the indoor heat exchange unit and the compressor or a hot gas decompression unit provided in the hot gas bypass during the hot gas heating operation.

### Effects of Invention

According to the present invention having these features, it is possible to adjust the heating capacity in hot gas heating which cannot be handled only by the control of the rotation speed of the compressor, and to efficiently continue hot gas heating in consideration of the durability of the compressor.

### BRIEF DESCRIPTION OF DRAWINGS

FIG. 1 is a diagram illustrating a system configuration example of a vehicle air-conditioning device according to an embodiment of the present invention.

FIG. 2 is a diagram illustrating a control device of the vehicle air-conditioning device according to the embodiment of the present invention.

FIG. 3 is a diagram illustrating operation of a refrigerant circuit in a hot gas heating operation in the vehicle air-conditioning device according to the embodiment of the present invention.

FIG. 4 is a diagram illustrating operation of the refrigerant circuit in a heat absorption heating operation in the vehicle air-conditioning device according to the embodiment of the present invention.

FIG. 5 is a flowchart showing a basic operation flow of the vehicle air-conditioning device according to the embodiment of the present invention.

FIG. 6 is a flowchart showing an operation flow during the hot gas heating operation.

FIG. 7 is a diagram illustrating a configuration example of a control device in an electric vehicle (EV) including the vehicle air-conditioning device.

### DESCRIPTION OF EMBODIMENTS

Hereinafter, an embodiment of the present invention will be described with reference to the drawings. In the following description, the same reference numerals in different drawings indicate parts having the same functions, and redundant description in the respective drawings is appropriately omitted. Note that a thick line in a refrigerant circuit 10 in the figure indicates a refrigerant channel through which refrigerant flows, a black thick line of the thick line indicates the flow of high-pressure refrigerant, and a gray thick line indicates the flow of decompressed low-pressure refrigerant. A broken line in the refrigerant circuit 10 indicates a refrigerant channel through which no refrigerant flows.

### System Configuration

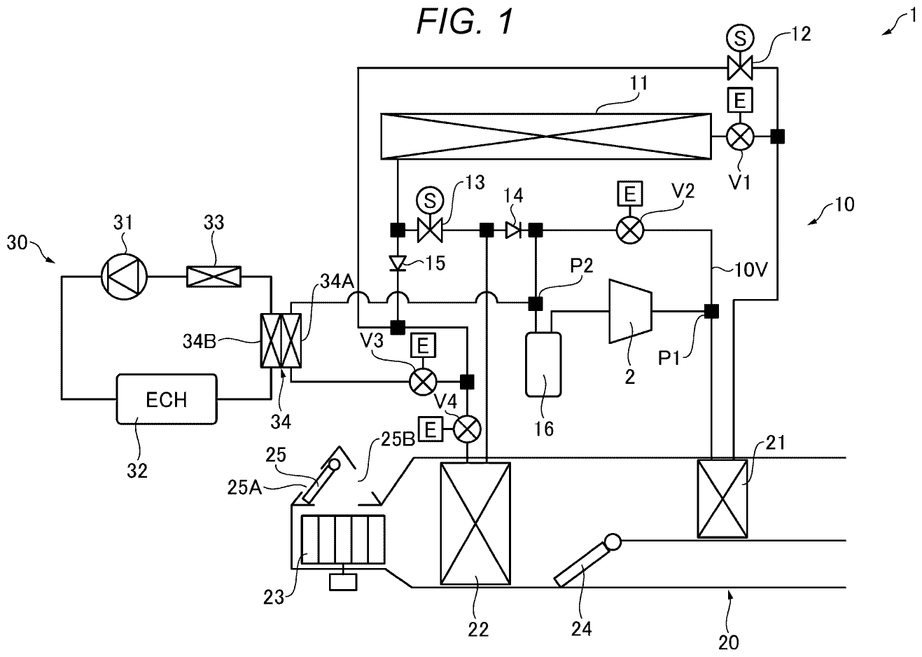

FIG. 1 illustrates a configuration example of a vehicle air-conditioning device 1 according to the embodiment of the present invention. The configuration example described here is an example, and is not particularly limited to a specific configuration.

The vehicle air-conditioning device 1 includes the refrigerant circuit 10 and an air-conditioning unit 20. The refrigerant circuit 10 includes a compressor 2, indoor heat exchangers 21, 22 provided inside the air-conditioning unit 20, and an external heat exchanger 11 provided outside a cabin, which are disposed along the refrigerant channel. The indoor heat exchangers 21, 22 are provided for heat exchange between air flowing in the air-conditioning unit 20 and the refrigerant, and the external heat exchanger 11 is provided for heat exchange between outside air and the refrigerant outside the cabin.

The compressor 2 of the refrigerant circuit 10 compresses and circulates the refrigerant. The refrigerant compressed by the compressor 2 is decompressed to a necessary pressure by passing through a first decompression unit V1, a second decompression unit V2, a third decompression unit V3, and a fourth decompression unit V4, which are expansion valves, for example, in the refrigerant channel appropriately selected. The refrigerant circuit 10 is provided with channel switching valves 12, 13 for switching the refrigerant channel, and as necessary, is provided with check valves 14, 15 for regulating a refrigerant flow direction. An accumulator 16 that recovers liquid refrigerant and separates the refrigerant into gas and liquid is provided immediately upstream of the compressor 2 in the refrigerant circuit 10.

As described above, the air-conditioning unit 20 includes the indoor heat exchangers 21, 22, and air introduced from inside or outside a room by a blower 23 selectively passes through the indoor heat exchangers 21, 22, and is blown into the room. The air-conditioning unit 20 is provided with an air damper 24. When the air damper 24 is fully opened as illustrated, the air introduced by the blower 23 passes through both the indoor heat exchangers 21, 22, and is blown into the room. When the air damper 24 is fully closed, the air introduced by the blower 23 passes only through the indoor heat exchanger 22, and is blown into the room. Another air damper 25 provided in the air-conditioning unit 20 switches the air to be introduced into the blower 23 between the inside and outside of the room, and selectively closes an air inlet port 25A connected to the outside of the room and an air inlet port 25B connected to the inside of the room.

Note that the example where in the external heat exchanger 11 and the indoor heat exchangers 21, 22 described above, the refrigerant and the air directly exchange heat has been described, but the refrigerant and the air may indirectly exchange heat through a heat medium having exchanged heat with the refrigerant. That is, the heat of the air may be absorbed by the refrigerant through the heat medium, or the heat of the refrigerant may be dissipated to the air through the heat medium.

The vehicle air-conditioning device 1 also includes a heat medium circuit 30 as necessary. In the heat medium circuit 30, the heat medium is circulated by a circulation pump 31, and accordingly, the heat medium is heated by a heater (ECH: electric coolant heater) 32, waste heat of a temperature adjustment target such as a battery is recovered by a temperature adjustment target heat exchanger 33, and the like. The refrigerant circuit 10 and the heat medium circuit 30 are provided with a refrigerant heat medium heat exchanger 34 that exchanges heat between the refrigerant and the heat medium in a channel 34A through which the refrigerant flows and a channel 34B through which the heat medium flows.

### Control Device

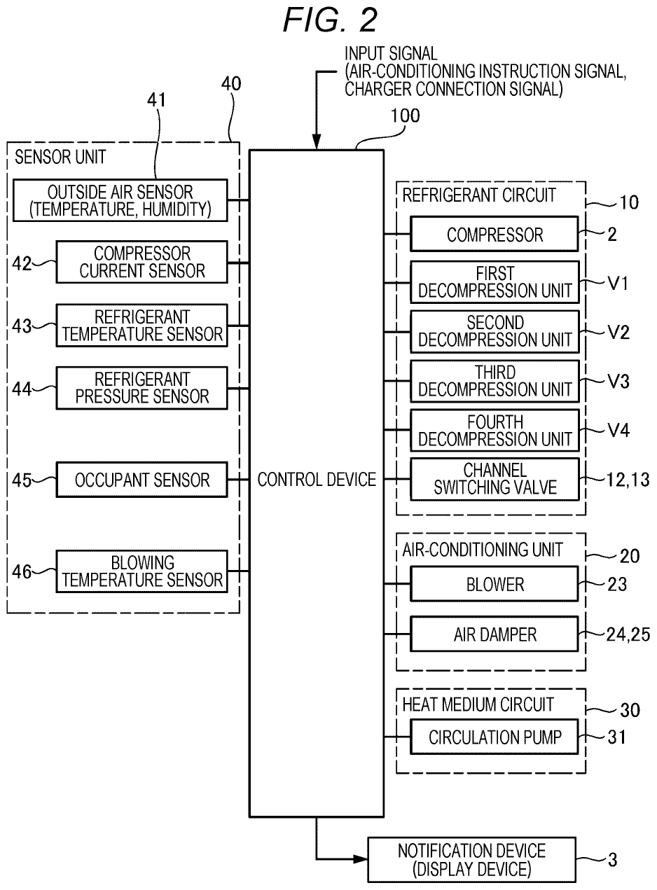

The vehicle air-conditioning device 1 includes a control device 100 illustrated in FIG. 2. The control device 100 controls the refrigerant circuit 10 and the air-conditioning unit 20 and the heat medium circuit 30 as necessary based on various input signals (air-conditioning instruction signal, charger connection signal, and the like) and a detection signal from a sensor unit 40.

The sensor unit 40 that inputs the detection signal to the control device 100 includes, for example, an outside air sensor 41 that detects an outside air state such as an outside air temperature and an outside air humidity, a compressor current sensor 42 that detects the power consumption (energy consumption) of the compressor 2, a refrigerant temperature sensor 43 and a refrigerant pressure sensor 44 that detect a refrigerant state, an occupant sensor 45 that detects the presence or absence of an occupant in the cabin, a blowing temperature sensor 46 that detects the blowing temperature of the air-conditioning unit 20, and the like. These sensors are an example. The sensor unit 40 includes various sensors that detect information necessary for the control device 100 to perform various types of control.

The control device 100 controls the compressor 2, the first decompression unit V1, the second decompression unit V2, the third decompression unit V3, the fourth decompression unit V4, and the like in the refrigerant circuit 10, the blower 23, the air dampers 24, 25, and the like in the air-conditioning unit 20, and the circulation pump 31 and the like in the heat medium circuit 30. The control device 100 controls the vehicle air-conditioning device 1 or a notification device (for example, display device such as an indicator or a monitor, or sound generation device such as an audio device) 3 included in the vehicle in accordance with the processing result of the control device 100.

### Hot Gas Heating Operation

In a hot gas heating operation, the refrigerant does not absorb heat in the external heat exchanger 11, and part or all of the refrigerant compressed by the compressor 2 dissipates heat in the indoor heat exchanger 21 to heat the inside of the cabin.

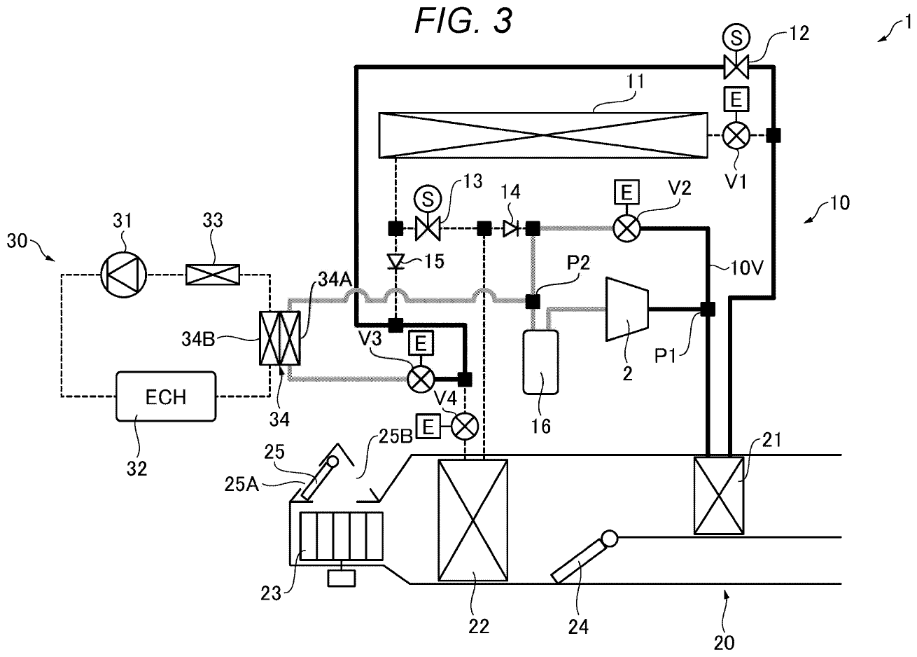

The operation of the refrigerant circuit 10 in the hot gas heating operation (including a preparatory operation) will be described with reference to FIG. 3. In this operation, part of the high-temperature high-pressure refrigerant discharged from the compressor 2 passes through the indoor heat exchanger 21 and the channel switching valve 12, is decompressed into the low-pressure refrigerant by the third decompression unit V3, passes through the refrigerant heat medium heat exchanger 34, is subjected to gas-liquid separation in the accumulator 16, and returns to the compressor 2. At this time, in the refrigerant circuit 10, the first decompression unit V1 is fully closed such that no refrigerant flows into the external heat exchanger 11. Moreover, the fourth decompression unit V4 is fully closed such that no refrigerant flows into the indoor heat exchanger 22.

The refrigerant circuit 10 includes a hot gas bypass 10V that decompresses at least part of the refrigerant compressed by compressor 2 without such refrigerant passing through the indoor heat exchanger 21 and the external heat exchanger 11 and returns the decompressed refrigerant to the compressor 2. In the hot gas bypass 10V, part of the high-temperature high-pressure refrigerant is branched at a branch point P1 immediately downstream of the compressor 2, is decompressed by the second decompression unit V2 (hot gas valve), and joins the low-pressure refrigerant decompressed by the third decompression unit V3 at a junction point P2 immediately upstream of the accumulator 16.

With such a hot gas bypass 10V, it is possible to mix the gas refrigerant having passed through the hot gas bypass 10V with the liquid refrigerant condensed by heat dissipation in the indoor heat exchanger 21 to obtain the gas-rich refrigerant and then return such refrigerant to the compressor 2. In addition, by increasing the flow rate of refrigerant flowing through the hot gas bypass 10V, the amount of heat dissipated in the indoor heat exchanger 21 can be reduced, and by adjusting the flow rate of refrigerant flowing through the hot gas bypass 10V by opening and closing the second decompression unit V2 (hot gas valve), a balance between the amount of heat dissipated in the refrigerant circuit 10 and the amount of heat input to the compressor 2 can be maintained.

The flow of refrigerant in the hot gas heating operation is decompressed by the third decompression unit V3 in the channel passing through the indoor heat exchanger 21, so that the refrigerant is the high-pressure refrigerant on the upstream side thereof and is the low-pressure refrigerant on the downstream side thereof. At this time, it is important not to perform heat exchange in the refrigerant heat medium heat exchanger 34 in the low-pressure side channel in order to maintain a heating capacity. Then, in the air-conditioning unit 20, the air introduced by the blower 23 is heated by heat dissipation in the indoor heat exchanger 21, and is blown into the cabin.

### Preparatory Operation

In the preparatory operation performed at the start of the hot gas heating operation, no heat is dissipated or such heat dissipation is suppressed in the indoor heat exchanger 21, and the refrigerant is circulated in the refrigerant circuit 10 until the refrigerant reaches a predetermined state. In one method, the operation of the refrigerant circuit 10 in the hot gas heating operation described above is executed in a state in which the operation of the blower 23 of the air-conditioning unit 20 is stopped or suppressed. In another method, the air damper 24 is fully closed in a state in which the blower 23 of the air-conditioning unit 20 is operated such that no air flows to the indoor heat exchanger 21, and then, the operation of the refrigerant circuit 10 in the hot gas heating operation described above is executed.

In the former method, since the air from the air-conditioning unit 20 is stopped or reduced, it is necessary to notify the occupant that the preparatory operation is being executed as described later. On the other hand, in the latter method, first, the air which does not pass through the indoor heat exchanger 21 flows from the air-conditioning unit 20, and thus, the discomfort to the occupant is eliminated by enabling the occupant to adjust the air quantity.

### Heat Absorption Heating Operation

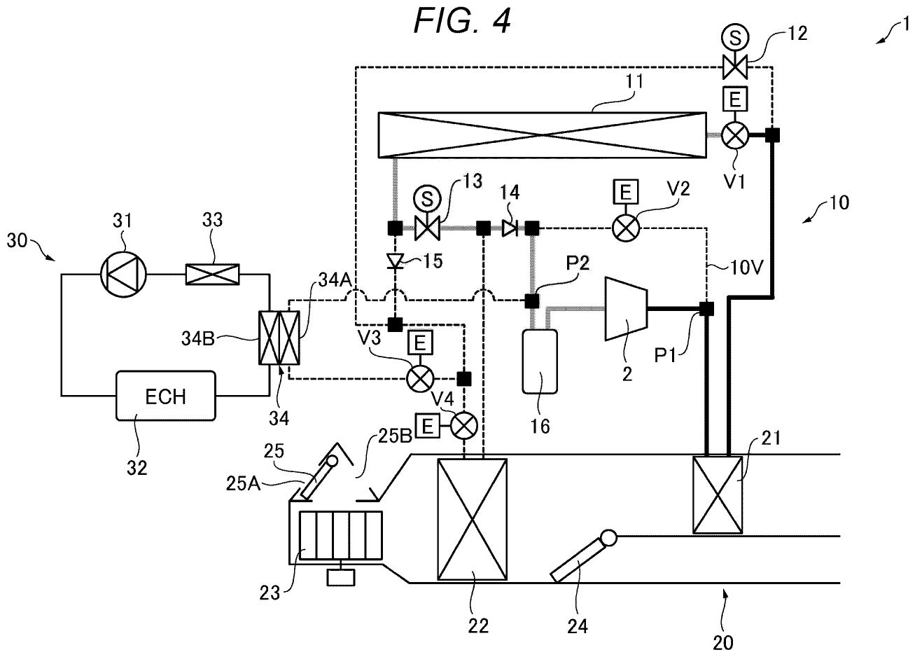

The operation of the refrigerant circuit 10 in a heat absorption heating operation will be described with reference to FIG. 4. In the refrigerant circuit 10 in the heat absorption heating operation, all the second decompression unit V2, the third decompression unit V3, the fourth decompression unit V4, and the channel switching valve 12 are all fully closed.

In the heat absorption heating operation, the high-temperature high-pressure refrigerant discharged from the compressor 2 passes through the indoor heat exchanger 21 in the air-conditioning unit 20 and is decompressed in the first decompression unit V1, and the low-pressure refrigerant passes through the external heat exchanger 11 and is returned to the compressor 2 through the channel switching valve 13, the check valve 14, and the accumulator 16. At this time, the high-pressure refrigerant discharged from the compressor 2 condenses and dissipates heat in the indoor heat exchanger 21, is decompressed into the low-pressure refrigerant in the first decompression unit V1, absorbs heat and evaporates in the external heat exchanger 11, and returns to the compressor 2. Then, in the air-conditioning unit 20, the air introduced by the blower 23 is heated by heat dissipation in the indoor heat exchanger 21, and is blown into the cabin.

### Basic Operation

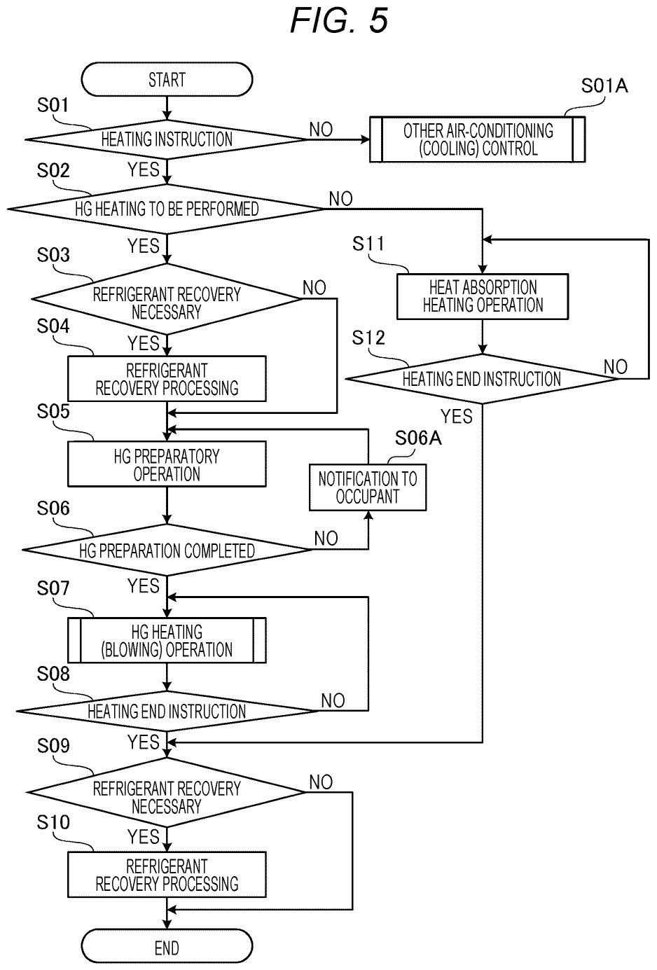

A basic operation of the vehicle air-conditioning device 1 by the control device 100 will be described with reference to FIG. 5. When the operation of the vehicle air-conditioning device 1 is started, the vehicle air-conditioning device 1 is brought into an air-conditioning instruction signal waiting state (Step S01). When the heating instruction is input here (Step S01: YES), the process proceeds to next Step S02. When an instruction other than the heating instruction (for example, cooling instruction) is input (Step S01: NO), the process proceeds to another air-conditioning control according to the instruction (Step S01A).

In next Step S02, it is determined whether to perform the hot gas heating operation. Since the hot gas heating operation is mainly performed in a situation where heat absorption heating cannot be performed, when it is determined that the hot gas heating operation should be performed (Step S02: YES), for example, when an extremely low temperature situation is detected by the outside air sensor 41, the process proceeds to next Step S03. When it is determined in Step S02 that the hot gas heating operation is not to be performed (Step S02: NO), the air suction heating operation described above is performed (Step S11).

In Step S03, from the state of the refrigerant in the refrigerant circuit 10, the state of the heating operation before the start, and the like, it is determined whether or not the condensed refrigerant is accumulated in the external heat exchanger 11, the refrigerant heat medium heat exchanger 34, or the like in the refrigerant circuit 10. When it is determined that the refrigerant is accumulated and refrigerant recovery is necessary (Step S03: YES), refrigerant recovery processing is performed (Step S04). When it is determined in Step S03 that the refrigerant recovery is not necessary (Step S03: NO), the refrigerant recovery processing (Step S04) is skipped. Note that when the refrigerant recovery processing is performed in Steps S09, S10 after the end of the heating, Steps S03, S04 can be omitted.

In Step S05, the above-described preparatory operation performed at the start of the hot gas heating operation is performed. In the preparatory operation, the operation of the refrigerant circuit 10 in the hot gas heating operation described above is performed in a state in which heat dissipation from the refrigerant circuit 10 is not performed or suppressed, and the circulating refrigerant is brought into a high-pressure state to accumulate energy in the refrigerant. In this preparatory operation (Step S05), the operation of the blower 23 of the air-conditioning unit 20 is stopped as described above.

The preparatory operation (Step S05) is continued until it is determined in Step S06 that the refrigerant state suitable for performing the hot gas heating operation is brought (Step S06: NO). During this period, processing of notifying the occupant in the cabin that the preparatory operation for the hot gas heating operation is being executed is performed such that the occupant does not feel uneasy or uncomfortable about device failure because the air is not blown out of the air-conditioning unit 20 (Step S06A).

Here, in the notification to the occupant (notification to occupant: Step S06A), output from the control device 100 to the notification device 3 is made to notify the occupant that the above-described preparatory operation is being executed. As an example, a display device included in the vehicle, such as an indicator or a monitor, displays the notification by blinking or on a monitor. As another example, the occupant is notified that the above-described preparatory operation is being executed by, for example, emitting voice or predetermined notification sound from a speaker included in the vehicle. As a result, it is possible to cause the occupant to recognize that the current situation where no air is blown is not the device failure or the like, but the preparatory operation for the normal hot gas heating operation.

When it is confirmed from the refrigerant pressure detection result, the detection result of the power consumption of the compressor 2, and the like that sufficient energy has been accumulated in the refrigerant in the preparatory operation, it is determined whether or not the preparatory operation has been completed (Step S06: YES), and the hot gas heating operation accompanied by air blowing is executed (Step S07).

The hot gas heating operation is executed until a heating end instruction is input (Step S08: NO). When the heating end instruction is input (Step S08: YES), similarly to Steps S03, S04, the determination on the necessity of the refrigerant recovery (Step S09) and the refrigerant recovery processing (Step S10) when necessary are performed, and the air-conditioning operation ends. Note that when Steps S03, S04 are executed at the time of the next air-conditioning operation, Steps S09, S10 can be omitted.

When the heat absorption heating operation is performed in Step S11, the operation is continued until a subsequent heating end instruction (Step S12: NO), and when the heating end instruction is issued (Step S12: YES), the determination on the necessity of the refrigerant recovery (Step S09) and the refrigerant recovery processing (Step S10) when necessary are performed, and the air-conditioning operation ends.

### Heating Capacity Adjustment in Hot Gas Heating Operation

When the instruction to adjust the heating capacity is issued during the hot gas heating operation, the control corresponding to the adjustment instruction is performed by appropriately combining the adjustment of the rotation speed of the compressor and the adjustment of the decompression unit (second decompression unit V2 and third decompression unit V3) of the hot gas heating refrigerant channel in consideration of the urgency of the instruction, the status of the rotation speed of the compressor, or the burden on the compressor.

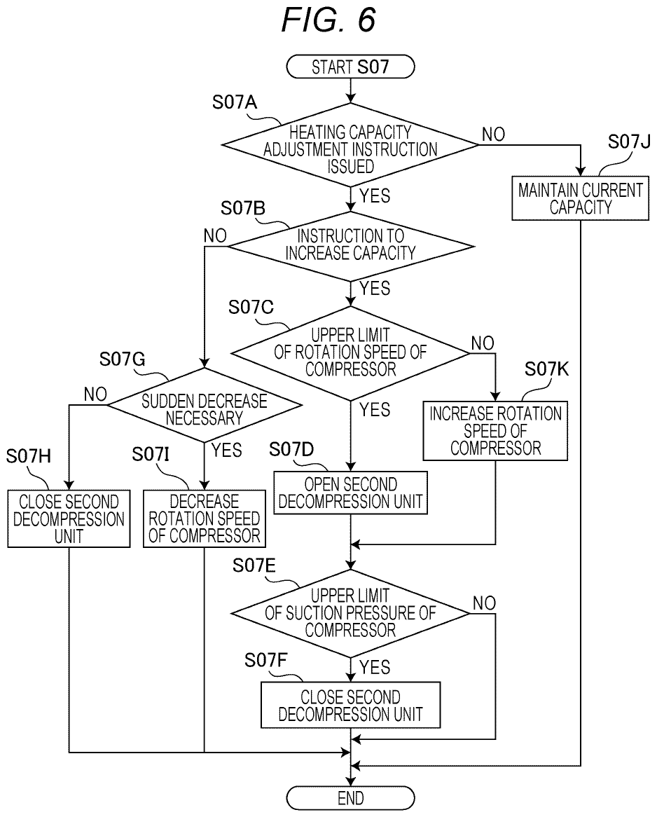

An example of the adjustment operation during the hot gas heating operation (Step S07) will be described with reference to FIG. 6. When the instruction to adjust the heating capacity is input during the hot gas heating operation (Step S07) (Step S07A: YES), it is determined whether the adjustment instruction is an instruction to increase the heating capacity or an instruction to decrease the heating capacity (Step S07B).

When the instruction to increase the heating capacity is issued (Step S07B: YES) and the status of the rotation speed of the compressor 2 indicates a rotation speed close to the upper limit value (Step S07C: YES), the second decompression unit V2 (hot gas valve) in the hot gas bypass 10V is adjusted to open in response to the instruction to increase the heating capacity. When the rotation speed of the compressor 2 is not close to the upper limit (Step S07C: NO), the rotation speed of the compressor 2 is increased (S07K) in response to the instruction to increase the heating capacity.

At this time, when the second decompression unit V2 is opened, the flow rate of refrigerant flowing through the hot gas bypass 10V increases, and accordingly, the flow rate of refrigerant returned to the compressor 2 increases. As a result, the load on the compressor 2 increases, and the power consumption increases. Accordingly, the amount of heat dissipated in the hot gas heating operation increases, and the heating capacity increases. Similarly, when the rotation speed of the compressor 2 is increased, the power consumption of the compressor 2 increases, and the heating capacity in the hot gas heating operation increases.

When the suction pressure of the compressor 2 reaches the vicinity of the upper limit while the heating capacity is being increased (Step S07E: YES), the second decompression unit V2 is adjusted to close in order to reduce the burden on the compressor 2 (Step S07F). By performing such adjustment, the durability of the compressor 2 can be maintained.

When the instruction to adjust the heating capacity is the instruction to decrease the heating capacity (Step S07B: NO), the necessity of a sudden decrease is determined based on the instruction contents (Step S07G). Here, for example, it is determined that the sudden decrease is necessary in a case of coping with manual adjustment urgently performed by the occupant or a sudden change in the outside air temperature such as traveling into a tunnel, and it is determined that the sudden decrease is unnecessary in a case of coping with a gentle change in the outside air temperature.

When it is determined that the sudden decrease is necessary (Step S07G: YES), the rotation speed of the compressor 2 is decreased (Step S07I) in response to the instruction to decrease the heating capacity. When it is determined that the sudden decrease is unnecessary (Step S07G: NO), the second decompression unit V2 of the hot gas bypass 10V is adjusted to close (Step S07H) in response to the instruction to decrease the heating capacity. When there is no instruction to adjust the heating capacity during the hot gas heating operation (Step S07A: NO), the current heating capacity is maintained (Step S07J).

Note that in the operation example illustrated in FIG. 6, the adjustment of opening and closing the second decompression unit V2 can be replaced with the adjustment of opening and closing the third decompression unit V3, or can be performed by cooperation of the second decompression unit V2 and the third decompression unit V3. Moreover, in the operation example illustrated in FIG. 6, when the suction pressure of the compressor 2 reaches the vicinity of the upper limit (Step S07E: YES), the second decompression unit V2 is adjusted to close to reduce the burden on the compressor 2 (Step S07F). However, when the discharge pressure of the compressor 2 is the upper limit value or when the air quantity of the blower 23 provided in the air-conditioning unit 20 is the upper limit value, the second decompression unit V2 may be adjusted to close.

### Configuration of Control Device in Electric Vehicle (EV)

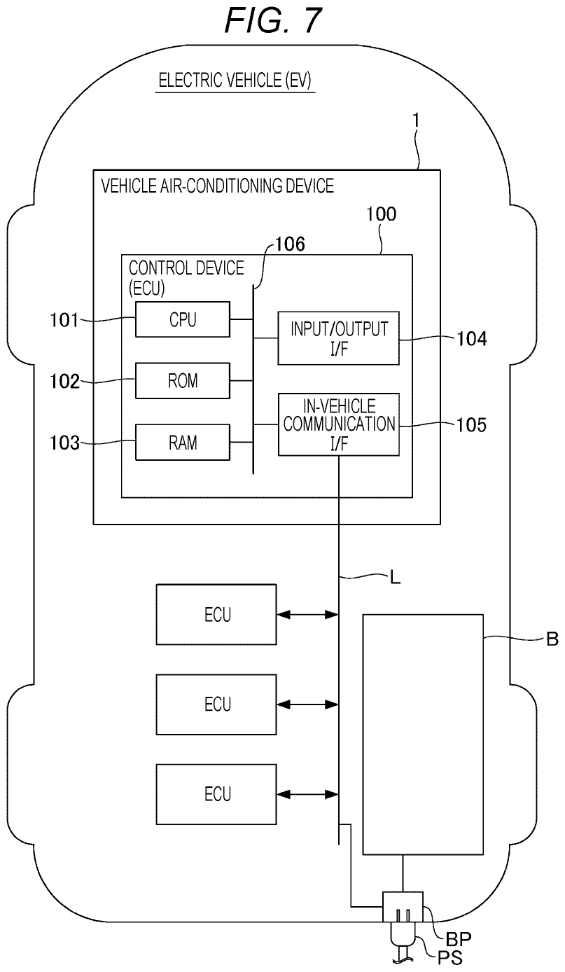

As illustrated in FIG. 7, the control device 100 included in the vehicle air-conditioning device 1 is configured as one ECU connected to various electronic control units (ECUs) that control an electric vehicle (EV) via an in-vehicle network L. The control device 100 includes a central processing unit (CPU) 101, a read only memory (ROM) 102, a random access memory (RAM) 103, an input/output interface (I/F) 104, an in-vehicle communication interface (I/F) 105, and the like, and these pieces of hardware are mutually connected via a bus 106.

The CPU 101 executes various programs stored in the ROM 102 to control the control device 100. The ROM 102 is a non-volatile memory. For example, the ROM 102 stores a program to be executed by the CPU 101, data necessary for the CPU 101 to execute the program, and the like. The RAM 103 is a main storage device such as a dynamic random access memory (DRAM) or a static random access memory (SRAM). For example, the RAM 103 functions as a work area used when the CPU 101 executes the program. The input/output I/F104 is connected to various sensors and monitors installed in the EV, inputs data to the CPU 101, and outputs data subjected to arithmetic processing by the CPU 101. The in-vehicle communication I/F105 is connected to the in-vehicle network L to control data transmission and reception with other ECUs set in the EV.

The control device 100 controls the vehicle air-conditioning device 1 described above according to the program executed by the CPU 101 when data on surrounding environmental information or data on the driving state of the EV is input via the input/output I/F104 or the in-vehicle communication I/F105.

A battery B is mounted on the EV. The battery B is charged by connecting a plug PS of a charger to a battery plug BP, and power is supplied to the vehicle air-conditioning device 1 through the battery B. The state in which the plug PS is connected to the battery plug BP is transmitted as the charger connection signal to the control device 100 via the in-vehicle network L.

Although the embodiments of the present invention have been described in detail above with reference to the drawings, the specific configuration is not limited to these embodiments, and modifications and the like of the design without departing from the gist of the present invention are also included in the present invention. Furthermore, each of the above-described embodiments can be combined by diverting their techniques as long as there is no particular contradiction or problem in the purpose, configuration, and the like.

### LIST OF REFERENCE SIGNS

1 VEHICLE AIR-CONDITIONING DEVICE
2 Compressor
3 Notification Device (Display Device)
10 Refrigerant Circuit
10V Hot Gas Bypass
11 External Heat Exchanger
12,13 Channel Switching Valve
14, 15 Check Valve
16 Accumulator
20 Air-Conditioning Unit
21,22 Indoor Heat Exchanger
23 Blower
30 Heat Medium Circuit
31 Circulation Pump
32 Heater
33 Temperature Adjustment Target Heat Exchanger
34 Refrigerant Heat Medium Heat Exchanger
24, 25 Air Damper
25A, 25B Air Inlet Port
40 Sensor Unit
41 Outside Air Sensor
42 Compressor Current Sensor
43 Refrigerant Temperature Sensor
44 Refrigerant Pressure Sensor
45 Occupant Sensor
46 Blowing Temperature Sensor
100 Control Device
V1 First Decompression Unit
V2 Second Decompression Unit
V3 Third Decompression Unit
V4 Fourth Decompression Unit

1. A vehicle air-conditioning device comprising:
a refrigerant circuit including a compressor, an indoor heat exchange unit, and an external heat exchange unit;
an air-conditioning unit in which the indoor heat exchange unit is disposed; and
a control device that controls the refrigerant circuit and the air-conditioning unit,
wherein the refrigerant circuit has a hot gas bypass that decompresses at least part of refrigerant compressed by the compressor without the refrigerant passing through the indoor heat exchange unit and the external heat exchange unit, and returns the decompressed refrigerant to the compressor, and
the control device
is capable of executing a hot gas heating operation of heating an inside of a cabin by causing part of the refrigerant compressed by the compressor to dissipate heat in the indoor heat exchange unit without causing the refrigerant to absorb heat in the external heat exchange unit, and
adjusts a heating capacity by opening and closing at least one of a decompression unit provided between the indoor heat exchange unit and the compressor or a hot gas decompression unit provided in the hot gas bypass during the hot gas heating operation.

2. The vehicle air-conditioning device according to claim 1, wherein
the control device
adjusts the decompression unit or the hot gas decompression unit to open in response to an instruction to increase a capacity in the hot gas heating operation when a rotation speed of the compressor is close to an upper limit value.

3. The vehicle air-conditioning device according to claim 1, wherein
the control device
adjusts the decompression unit or the hot gas decompression unit to close in response to an instruction to increase a capacity in the hot gas heating operation when a suction pressure of the compressor is an upper limit value.

4. The vehicle air-conditioning device according to claim 1, wherein
the control device
adjusts the decompression unit or the hot gas decompression unit to close in response to an instruction to increase a capacity in the hot gas heating operation when a discharge pressure of the compressor is an upper limit value.

5. The vehicle air-conditioning device according to claim 1, wherein
the control device
adjusts the decompression unit or the hot gas decompression unit to close in response to an instruction to increase a capacity in the hot gas heating operation when an air quantity of a blower provided in the air-conditioning unit is an upper limit value.
